(19) United States
(12) Patent Application Publication
(10) Pub. No.: US 2005/0070203 A1
(43) Pub. Date: Mar. 31, 2005

(54) Electromotive top

(76) Inventor: Roderick John Beckett, Irving, TX (US)

Correspondence Address: Roderick J. Beckett, 2733 West Royal Lane, #1604, Irving, TX, 75063, US

(21) Appl. No.: 10/803,370

(22) Filed: Mar. 18, 2004

Related U.S. Application Data
(60) Provisional application No. 60/455,641, filed on Mar. 18, 2003.

(51) Int. Cl. G11B 17/08; A63H 1/06

(52) U.S. Cl. 446/259

(57) ABSTRACT

Electromotive tops entertain the user while teaching principles of physics. Two embodiments are disclosed. The first embodiment has a motor and a motor shaft that are inserted into a top body with a flywheel attached to its top. A retainer connects the motor shaft to the top body. Motor terminals protrude from the motor. The second embodiment has a motor with a motor shaft that is connected to a spindle sleeve. A spacer, spindle nut, and spindle secure one or more standard compact discs to the spindle sleeve. A housing and facing enclose the motor and a plurality of capacitors. The capacitors power LEDs attached to the facing. Motor terminals protrude from the motor through the housing. The spindle can be unscrewed using a thumbscrew to allow the user to add and/or remove one or more compact discs from the spindle sleeve as desired.

### BACKGROUND OF THE INVENTION

1. Field of the Invention

The present invention relates to an electromotive top for use in connection with education. The electromotive top has particular utility in connection with entertaining the user while teaching principles of physics.

2. Description of the Prior Art

Electromotive tops are desirable for entertaining the user while teaching principles of physics. Traditional tops are severely limited in the length of time they spin because typical manual spinning methods result in relatively low rotation speeds. Electromotive tops use an electric motor to spin up, thereby reaching a much higher peak rotation speed. Also, a much heavier top can be spun up, resulting in the top spinning for a longer duration because of inertia. In addition, in the case of one embodiment of the electromotive top, the user can employ one or more standard compact disks and LEDs to personalize the electromotive top and create an attractive light display.

The use of top and launcher boxing simulation games and methods is known in the prior art. For example, U.S. Pat. No. 5,026,057 to Watford discloses a top and launcher boxing simulation game and method. However, the Watford '057 patent does not have a motor in the top, and has further drawbacks of lacking moving parts inside of the top.

U.S. Pat. No. 4,277,912 to Hsien discloses a gyroscope-monocycle that stands by its own gyroscopic action. However, the Hsien '912 patent does not have its batteries disconnected from the motor while spinning, and additionally does not spin down unless its batteries discharge or it is switched off.

Similarly, U.S. Pat. No. 3,246,427 to Tuuri discloses an electric top with power source and centrifugal switch that initiates and maintains rotation of the top with intermittent operation of the driving means. However, the Tuuri '427 patent does not spin down unless it is switched off, and cannot function in a vacuum because it requires air resistance.

In addition, U.S. Pat. No. 6,685,531 to Tiefel et al. discloses an electric toy top device with support and its associated method of operation that contains an internal electric motor that is periodically powered by a separate remote electric source. However, the Tiefel et al. '531 patent does not allow the top to travel while it spins, and also does not spin down unless it is switched off.

Furthermore, U.S. Pat. No. 5,683,284 to Christen discloses a gyroscopic top toy that demonstrates physical principles of inertia and moment. However, the Christen '284 patent does not disconnect the batteries from the motor while the top spins, and further lacks the ability to spin down unless the batteries discharge or it is switched off.

U.S. Pat. No. 3,533,187 to Campbell discloses a power integrated gyroscopic device that spins. However, the Campbell '187 patent does not disconnect the batteries from the motor while the top spins, and has the additional deficiency of not spinning down unless the batteries discharge or it is switched off.

In addition, U.S. Pat. No. 3,224,142 to Pawelka et al. discloses a top holding and spinning device with electric motor drive that spins a top. However, the Pawelka et al. '142 patent does not have a motor in the top, and also does not function without magnets.

Furthermore, U.S. Pat. No. 6,419,544 to Parker et al. discloses a battery powered gyroscopic entertainment device and system that exhibits gyroscopic action for a longer time period than string-powered toy devices. However, the Parker et al. '544 patent does not function without multiple weights, and further lacks the ability to function without attaching weights to both ends of the motor shaft.

Lastly, U.S. Pat. No. 4,713,039 to Wong discloses a gyroscopic toy that emits unusual sounds and lights during operation. However, the Wong '039 patent does not have the battery disconnected from the motor while spinning the, and has the additional deficiency of not spinning down unless the batteries discharge or it is switched off.

While the above-described devices fulfill their respective, particular objectives and requirements, the aforementioned patents do not describe an electromotive top that allows entertaining the user while teaching principles of physics. The Watford '057 patent and the Pawelka et al. '142 patent make no provision for a motor in the top. The Watford '057 patent lacks moving parts inside of the top. The Hsien '912 patent, the Christen '284 patent, the Campbell '187 patent, and the Wong '039 patent do not disconnect their batteries from the motor while spinning. The Hsien '912 patent, the Christen '284 patent, the Campbell '187 patent, and the Wong '039 patent cannot spin down unless their batteries discharge or they are switched off. The Tuuri '427 patent and the Tiefel et al. '531 patent cannot spin down unless they are switched off. The Tuuri '427 patent cannot function in a vacuum. The Tiefel et al. '531 patent does not allow the top to travel while it spins. The Pawelka et al. '142 patent does not function without magnets. The Parker et al. '544 patent does not function without multiple weights, and further lacks the ability to function without attaching weights to both ends of the motor shaft.

Therefore, a need exists for a new and improved electromotive top that can be used for entertaining the user while teaching principles of physics. In this regard, the present invention substantially fulfills this need. In this respect, the electromotive top according to the present invention substantially departs from the conventional concepts and designs of the prior art, and in doing so provides an apparatus primarily developed for the purpose of entertaining the user while teaching principles of physics.

### SUMMARY OF THE INVENTION

In view of the foregoing disadvantages inherent in the known types of top and launcher boxing simulation games and methods now present in the prior art, the present invention provides an improved electromotive top, and overcomes the above-mentioned disadvantages and drawbacks of the prior art. As such, the general purpose of the present invention, which will be described subsequently in greater detail, is to provide a new and improved electromotive top which has all the advantages of the prior art mentioned heretofore and many novel features that result in an electromotive top which is not anticipated, rendered obvious, suggested, or even implied by the prior art, either alone or in any combination thereof.

To attain this, the present invention essentially comprises a top body with a motor hole in its top and a retainer hole in its middle. A retainer with a motor shaft hole is inserted into the retainer hole. One end of a motor shaft is removably inserted into the motor shaft hole. One end of a motor is connected to the opposing end of the motor shaft. A flywheel is attached to the top of the top body. A plurality of motor terminals has one end attached to the motor's opposing end.

There has thus been outlined, rather broadly, the more important features of the invention in order that the detailed description thereof that follows may be better understood and in order that the present contribution to the art may be better appreciated.

The invention may also include a power source removably attached to the motor terminals. The power source may comprise a battery holder with a battery inserted into it and a plurality of battery holder terminals attached to one of its ends. The power source may be disconnected from the motor terminals once the top body and the flywheel reach the desired speed of rotation until the top body and the flywheel stop spinning. There may be a tip attached to the bottom of the top body. The flywheel may encircle the motor. The top body may be selected from the group consisting of plastic, steel, aluminum, titanium, wood, and carbon fiber composite. The flywheel may be selected from the group consisting of plastic, steel, aluminum, titanium, and wood. The top of the top body may be generally cylindrical in shape. The bottom of the top body may be generally conical in shape. There may be a spindle sleeve with a second motor shaft hole in its top that receives the opposing end of the motor shaft and a spindle hole in its bottom. There may be a flywheel frictionally engaged with the bottom of the spindle sleeve. There may be a spacer with a spindle sleeve hole in its middle with the bottom of the spindle sleeve removably inserted through the spindle sleeve hole. There may be a spindle nut with a spindle hole in its middle and its top frictionally engaged with the spacer. There may be a spindle with one end threadedly connected to the spindle nut and the spindle sleeve. There may be a thumbscrew attached to the middle of the spindle. There may be a plurality of capacitors connected in series by a plurality of capacitor wires to the motor terminals. There may be a plurality of diodes connected to the capacitors. There may be a plurality of LED wires with one end connected to the capacitors. There may be a first LED connected to the opposing end of the LED wires. There may be a second LED connected to the opposing end of the LED wires. There may be a housing enclosing the top of the motor with a plurality of motor terminal holes in its top. There may be a facing attached to the bottom of the housing with a first motor shaft hole in its middle. The spindle sleeve may be transparent or translucent. There may be a light groove in the top of the spindle sleeve. The bottom of the spindle sleeve may be adapted to fit the center hole of at least one standard compact disc. The flywheel may be a standard compact disc. The invention may be a method of using an electromotive top comprising the steps of obtaining an electromotive top, holding the electromotive top in an upright position by the opposing end of the motor, connecting the battery holder terminals to the motor terminals, waiting for the motor to bring the top body and the flywheel to the desired speed of rotation, disconnecting the battery holder terminals from the motor terminals, placing the bottom of the top body on a surface, and waiting for the electromotive top to stop spinning. There are, of course, additional features of the invention that will be described hereinafter and which will form the subject matter of the claims attached.

Numerous objects, features, and advantages of the present invention will be readily apparent to those of ordinary skill in the art upon a reading of the following detailed description of presently current, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved electromotive top that has all of the advantages of the prior art top and launcher boxing simulation games and methods and none of the disadvantages.

It is another object of the present invention to provide a new and improved electromotive top that may be easily and efficiently manufactured and marketed.

An even further object of the present invention is to provide a new and improved electromotive top that has a low cost of manufacture with regard to both materials and labor, and which accordingly is then susceptible of low prices of sale to the consuming public, thereby making such electromotive top economically available to the buying public.

Still another object of the present invention is to provide a new electromotive top that provides in the apparatuses and methods of the prior art some of the advantages thereof, while simultaneously overcoming some of the disadvantages normally associated therewith.

Even still another object of the present invention is to provide an electromotive top for entertaining the user while teaching principles of physics. This allows the user to spin the electromotive top at a high speed of rotation.

Still yet another object of the present invention is to provide an electromotive top for entertaining the user while teaching principles of physics. This makes it possible to adjust the rotational mass of the electromotive top.

An additional object of the present invention is to provide an electromotive top for entertaining the user while teaching principles of physics. This makes it easy for the user to see the electromotive top in dark conditions.

A further object of the present invention is to provide an electromotive top for entertaining the user while teaching principles of physics. This allows the user to personalize the electromotive top.

Lastly, it is an object of the present invention to provide a new and improved electromotive top for entertaining the user while teaching principles of physics.

These together with other objects of the invention, along with the various features of novelty that characterize the invention, are pointed out with particularity in the claims annexed to and forming a part of this disclosure. For a better understanding of the invention, its operating advantages, and the specific objects attained by its uses, reference should be had to the accompanying drawings and descriptive matter in which there is illustrated current embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a top perspective view of the current embodiment of the electromotive top constructed in accordance with the principles of the present invention.

FIG. 2 is a top view of the top body of the present invention.

FIG. 3 is a side exploded view of the electromotive top of the present invention.

FIG. 4 is a top perspective exploded view of the electromotive top of the present invention.

FIG. 5 is a side sectional view of an alternative embodiment of the electromotive top of the present invention.

FIG. 6 is a side exploded view of the motor of the present invention.

FIG. 7 is a top sectional view of the facing of the present invention.

FIG. 8 is a side sectional exploded view of the spindle sleeve of the present invention.

FIG. 9 is a bottom side view of the spindle sleeve of the present invention.

The same reference numerals refer to the same parts throughout the various figures.

### DESCRIPTION OF THE CURRENT EMBODIMENT

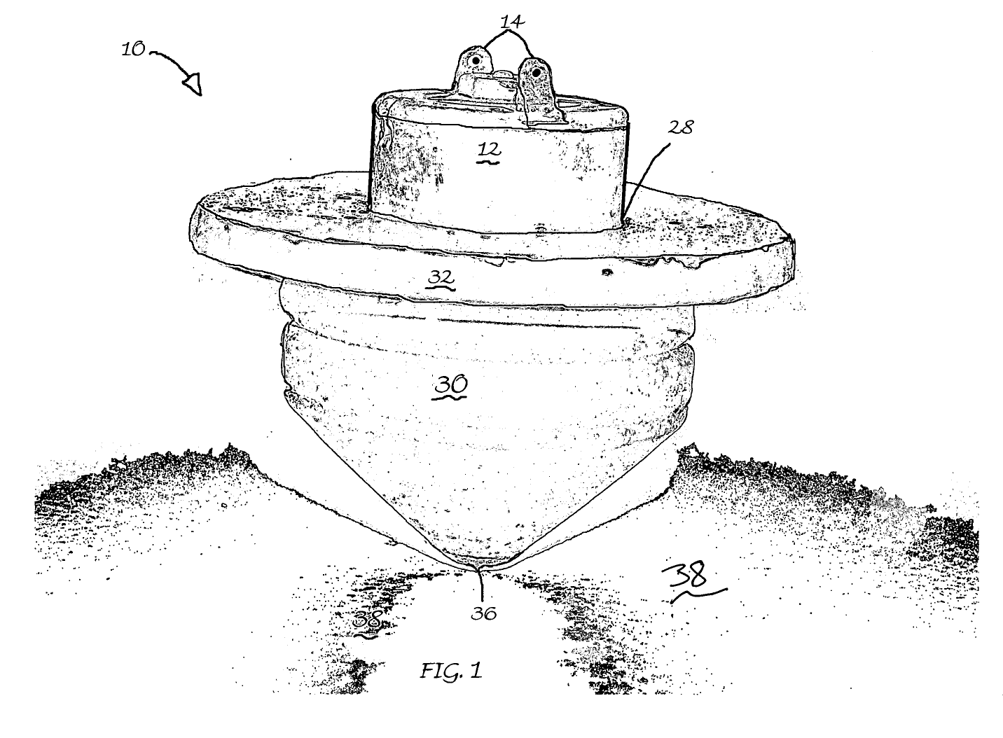

Referring now to the drawings, and particularly to FIGS. 1-9, a current embodiment of the electromotive top of the present invention is shown and generally designated by the reference numeral 10.

In FIG. 1, a new and improved electromotive top 10 of the present invention for entertaining the user while teaching principles of physics is illustrated and will be described. More particularly, the electromotive top 10 has a motor 12 with motor terminals 14 protruding from its top. The motor 12 is inserted into the top of a top body 30. A tip 36 protrudes from the bottom of the top body 30 to support the electromotive top 10 while it spins. A flywheel 32 encircles the motor 12 and is attached to the top of the top body 30. When the motor terminals 14 are connected to a source of electricity, they conduct electricity and cause the motor 12 to spin the top body 30, tip 36, and flywheel 32. The flywheel 32 imparts additional mass to the top body 30, thereby prolonging the spinning of the electromotive top 10 once the motor 12 is disconnected from the source of electricity. The electromotive top 10 is shown in use with the flywheel 32, top body 30, and tip 36 spinning on top of a surface 38. In the current embodiment, motor 12 is electric, flywheel 32 and tip 36 are made of steel, and top body 30 is made of wood. The top of the top body 30 is generally cylindrical in shape and the bottom of the top body 30 is generally conical in shape in the current embodiment.

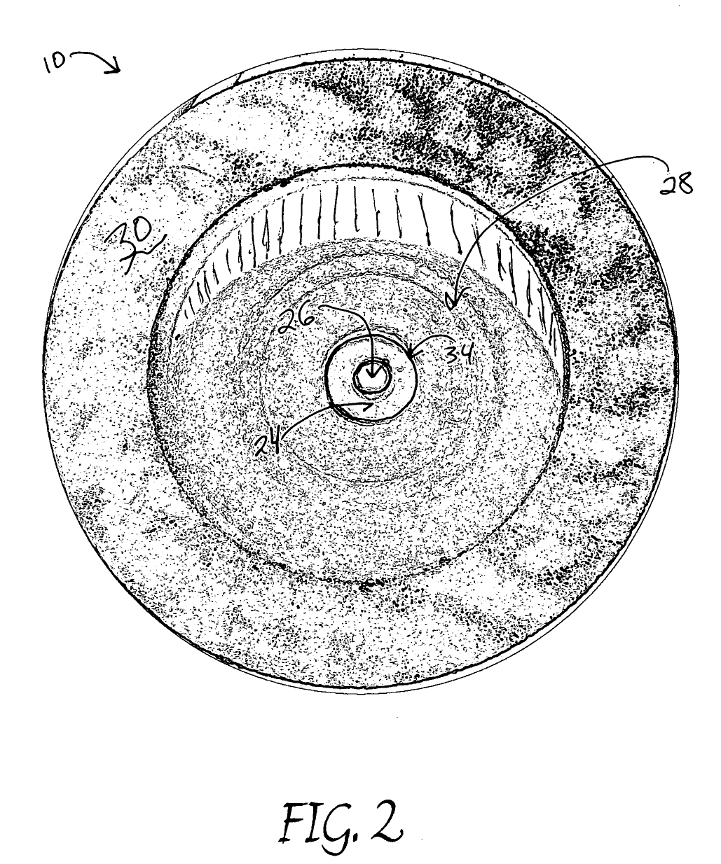

Moving on to FIG. 2, a new and improved top body 30 of the present invention for entertaining the user while teaching principles of physics is illustrated and will be described. More particularly, the top body 30 has a motor hole 28 in its top to receive the motor 12 (not shown). The top body 30 also has a retainer hole 26 in its middle at the bottom of the motor hole 28. A retainer 24 is inserted into the retainer hole 26. The retainer 24 has a motor shaft hole 34 in its center to receive a motor shaft 22 (not shown). The retainer 24 frictionally engages the motor shaft 22 with the top body 30 so that the motor shaft 22 spins the top body 30 when the motor 12 is energized.

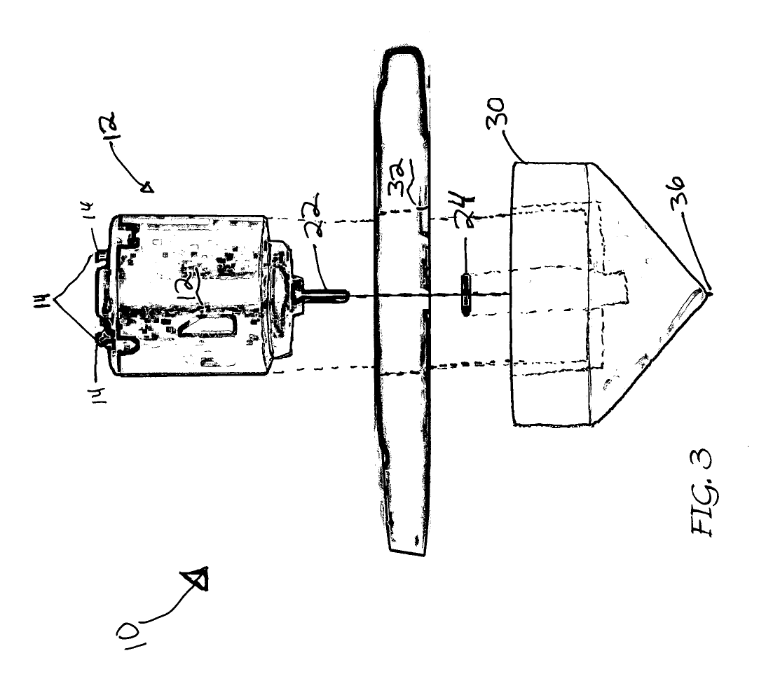

Continuing with FIG. 3, a new and improved electromotive top 10 of the present invention for entertaining the user while teaching principles of physics is illustrated and will be described. More particularly, the electromotive top 10 has a motor 12 with motor terminals 14 protruding from its top and a motor shaft 22 protruding from its bottom. The motor 12 is inserted through the flywheel 32 and into the top of the top body 36. The motor shaft 22 is inserted into the retainer 24. The flywheel 32 is secured to the top of the top body 30.

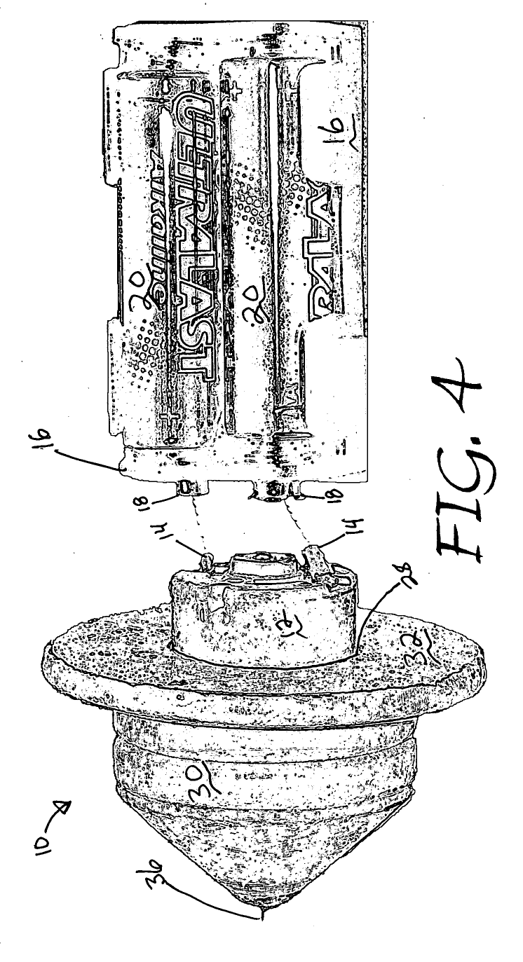

In FIG. 4, a new and improved electromotive top 10 of the present invention for entertaining the user while teaching principles of physics is illustrated and will be described. More particularly, the electromotive top 10 has a motor 12 with motor terminals 14 protruding from its top. The motor 12 is inserted into the top of a top body 30. A tip 36 protrudes from the bottom of the top body 30. A flywheel 32 encircles the motor 12 and is attached to the top of the top body 30. When the motor terminals 14 are connected to battery holder terminals 18 attached to a battery holder 16, they conduct electricity from the batteries 20 and cause the motor 12 to spin the top body 30, tip 36, and flywheel 32. In the current embodiment, batteries 20 are AA batteries.

Furthermore, in FIG. 5, an alternative embodiment of the new and improved electromotive top 10 of the present invention for entertaining the user while teaching principles of physics is illustrated and will be described. More particularly, the electromotive top 10 has a housing 40 with a facing 46 attached to its bottom that together enclose a motor 12, capacitors 48, diodes 56, LED wires 64, and capacitor wires 62. The capacitor wires 62 connect the capacitors 48 in series to motor terminals 14. The diodes 56 prevent the capacitors 48 from operating the motor 12. Motor terminals 14 are connected to the top of the motor 12 and protrude from the top of the housing 40 through motor terminal holes 72. First LEDs 42 and second LEDs 44 are attached to the bottom of the facing 46 and are connected to the capacitors 48 by the LED wires 64. A motor shaft 22 has one end connected to the bottom of the motor 12 and its opposing end inserted through a first motor shaft hole 80 in the facing 46 into a second motor shaft hole 74 in a spindle sleeve 50. Two compact discs 60 are held in place on the spindle sleeve 50 by a spacer 52 with a spindle sleeve hole 78 in its center and a spindle nut 54. The compact discs 60 impart additional mass to the spindle sleeve 50, thereby prolonging the spinning of the electromotive top 10 once the motor 12 is disconnected from the source of electricity. The compact discs 60 also reflect light emitted by the first LEDs 42 and second LEDs 44 to give the electromotive top 10 an attractive appearance and render it visible in dark conditions. Depending upon the effect desired and the optical properties of the sides of the compact discs 60, the user (not shown) can place the compact discs 60 either right side up or upside down on the spindle sleeve 50. The user can also personalize the appearance of the electromotive top 10 by employing compact discs 60 that are attractive to him or her. A spindle 58 is inserted into spindle holes 76 in the spindle nut 54 and spindle sleeve 50 to support the electromotive top 10 during operation. The spindle 58 has a thumbscrew 70 in its middle to facilitate attaching and detaching the spindle 58 from the spindle nut 54. A light groove 68 is formed in the top of the spindle sleeve 50 to refract light 66. In the current embodiment, the spindle nut 54 and spindle 58 are threadedly connected to one another and the bottom of the spindle sleeve 50 is adapted to fit the center hole of a standard compact disc 60.

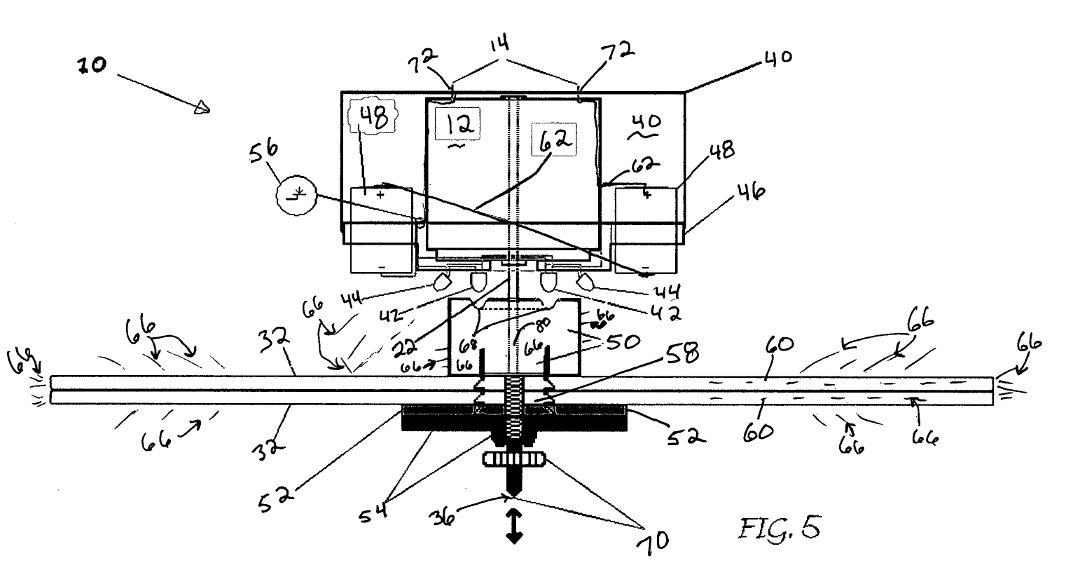

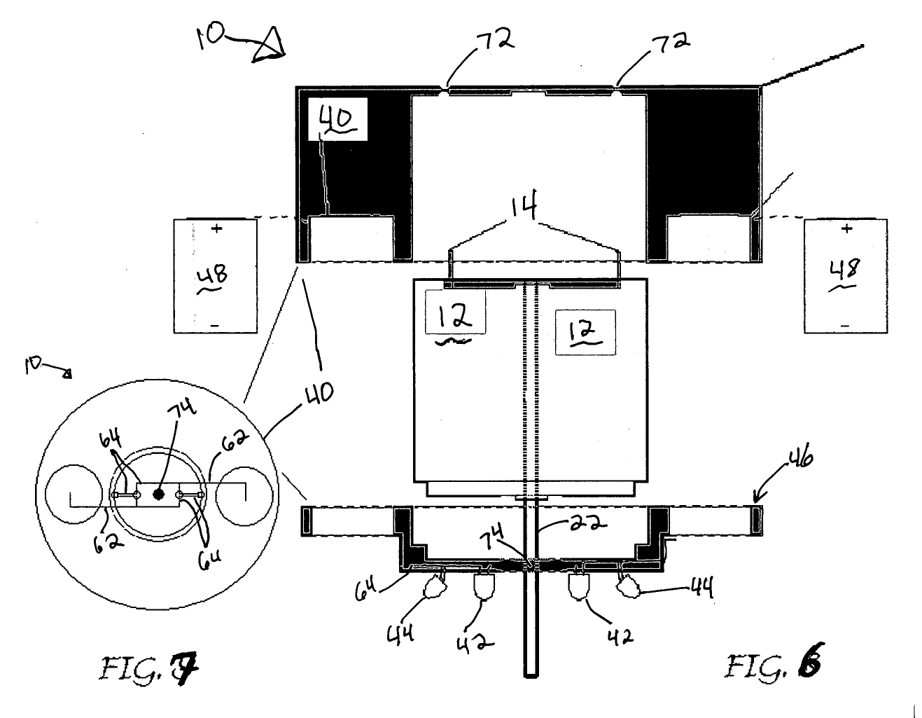

Moving on to FIG. 6, a new and improved motor 12 of the present invention for entertaining the user while teaching principles of physics is illustrated and will be described. More particularly, the motor 12 is enclosed by a housing 40 with a facing 46 attached to its bottom. Capacitors 48, diodes 56, LED wires 64, and capacitor wires 62. The capacitor wires 62 connect the capacitors 48 in series to motor terminals 14. Motor terminals 14 are connected to the top of the motor 12 and protrude from the top of the housing 40 through motor terminal holes 72. First LEDs 42 and second LEDs 44 are attached to the bottom of the facing 46 and are connected to the capacitors 48 by the LED wires 64. A motor shaft 22 has one end connected to the bottom of the motor 12 and its opposing end is inserted through a first motor shaft hole 80 in the facing 46.

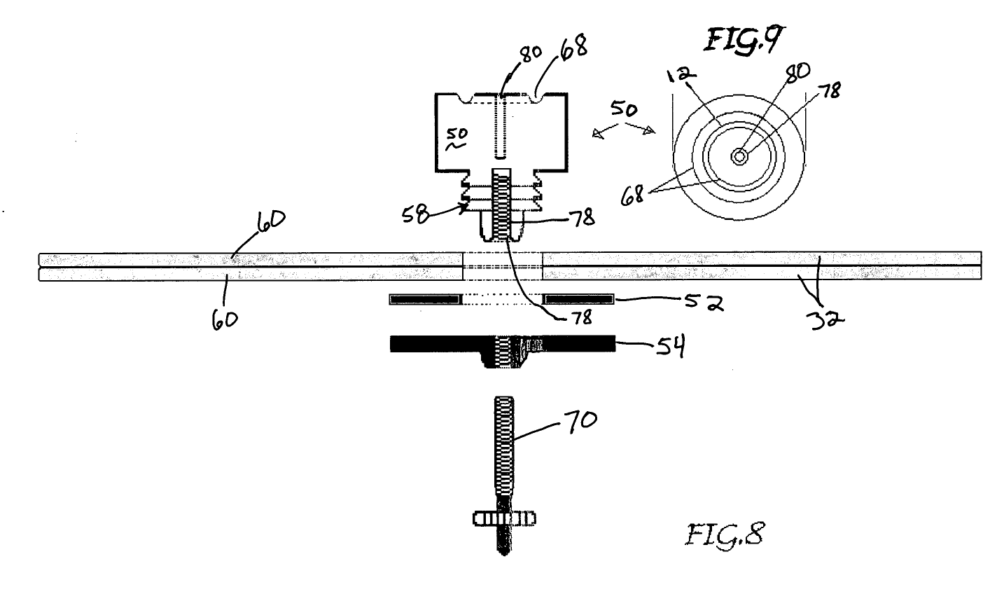

Continuing with FIG. 7, a new and improved facing 46 of the present invention for entertaining the user while teaching principles of physics is illustrated and will be described. More particularly, the facing 46 encloses the bottom of the capacitors 48. LED wires 64 connect the first LEDs 42 and second LEDs 44 to the capacitors 48.

Furthermore, in FIG. 8, a new and improved spindle sleeve 50 of the present invention for entertaining the user while teaching principles of physics is illustrated and will be described. More particularly, the spindle sleeve 50 has a motor shaft hole 74 to receive one end of the motor shaft 22 (not shown). Two compact discs 60 are held in place on the spindle sleeve 50 by a spacer 52 with a spindle sleeve hole 78 in its center and a spindle nut 54. A spindle 58 is inserted into spindle holes 76 in the spindle nut 54 and spindle sleeve 50. The spindle 58 has a thumbscrew 70 in its middle. A light groove 68 is formed in the top of the spindle sleeve 50.

Concluding with FIG. 9, a new and improved spindle sleeve 50 of the present invention for entertaining the user while teaching principles of physics is illustrated and will be described. More particularly, the spindle sleeve 50 has a spindle hole 76 in its bottom, which is adapted to fit the center hole of a standard compact disc 60 (not shown). In the current embodiment, the spindle sleeve 50 is made of a translucent plastic.

In use, it can now be understood that in the case of the first embodiment of the electromotive top 10, the user holds the top of the motor 12 to support the electromotive top 10 in an upright position above a surface 38. The user then connects the battery holder terminals 18 with the motor terminals 14 until the motor 12 spins up the top body 30, flywheel 32, and tip 36 to the desired speed. The user then places the tip 36 in contact with the surface 38 with the electromotive top 10 in an upright position and releases the electromotive top 10. The electromotive top 10 gradually depletes its kinetic energy over time and eventually falls over and comes to a stop. The user can then repeat the process if desired.

In use, it can now be understood that in the case of the second embodiment of the electromotive top 10, the user holds the top of the housing 40 to support the electromotive top 10 in an upright position above a surface 38. When the user connects the motor terminals 14 to the battery holder terminals 18, the capacitors 48 are charged and the motor 12 spins the motor shaft 22. In turn, the motor shaft 22 spins the spindle sleeve 50, compact discs 60, and spindle 58. Once the electromotive top 10 reaches the desired speed of rotation, the user places the spindle 58 in contact with the surface 38 with the electromotive top 10 in an upright position and releases the electromotive top 10. Capacitors 48 power the first LEDs 42 and second LEDs 44 until they are discharged. Light 66 emitted from the first LEDs 42 reflects off the compact discs 60. Light 66 emitted from the second LEDs is refracted by the light groove 68 and passes through the spindle sleeve 50. The light 66 emitted by the first LEDs 42 and second LEDs 44 allows the user (not shown) to easily locate the electromotive top 10 in a dark environment and give the electromotive top 10 an attractive appearance. The electromotive top 10 gradually depletes its kinetic energy over time and eventually falls over and comes to a stop. The user can then repeat the process if desired. The user can also add and/or remove compact discs 60 by unscrewing the spindle 58 using the thumbscrew 70, removing the spindle nut 54 and spacer 52, adding and/or removing one or more compact discs 60, replacing the spacer 52 and spindle nut 54, and screwing the spindle 58 into the spindle holes 76 using the thumbscrew 70.

While a current embodiment of the electromotive top has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, any suitable sturdy material such as plastic, steel, aluminum, titanium, or carbon fiber composite may be used instead of the wooden top body described. Also, the steel flywheel may also be made out of plastic, aluminum, titanium, wood, lead, or one or more standard compact discs. Furthermore, a wide variety of power sources may be used instead of the AA batteries described.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An electromotive top comprising:
a top body having a top, a bottom, and a middle;
a motor hole, wherein said top of said top body defines a hole therein to comprise said motor hole;
a retainer hole, wherein said middle of said top body defines a hole therein to comprise said retainer hole;
a retainer inserted into said retainer hole;
a motor shaft hole, wherein said retainer defines a hole therein to comprise said retainer hole;
a motor shaft having opposing ends with one end removably inserted into said motor shaft hole;
a motor having opposing ends with one end connected to said opposing end of said motor shaft;
a flywheel attached to said top of said top body; and
a plurality of motor terminals having opposing ends with one end attached to said opposing end of said motor.

2. The electromotive top as defined in claim 1, further comprising a power source removably attached to said motor terminals.

3. The electromotive top as defined in claim 2, wherein said power source comprises:
a battery holder having opposing ends;
a battery inserted into said battery holder; and
a plurality of battery holder terminals attached to one of said ends of said battery holder.

4. The electromotive top as defined in claim 2, wherein said power source is disconnected from said motor terminals once said top body and said flywheel reach the desired speed of rotation until said top body and said flywheel stop spinning.

5. The electromotive top as defined in claim 1, further comprising a tip attached to said bottom of said top body.

6. The electromotive top as defined in claim 1, wherein said flywheel encircles said motor.

7. The electromotive top as defined in claim 1, wherein said top body is selected from the group consisting of plastic, steel, aluminum, titanium, wood, and carbon fiber composite.

8. The electromotive top as defined in claim 1, wherein said flywheel is selected from the group consisting of plastic, steel, aluminum, titanium, lead, and wood.

9. The electromotive top as defined in claim 1, wherein said top of said top body is generally cylindrical in shape.

10. The electromotive top as defined in claim 1, wherein said bottom of said top body is generally conical in shape.

11. An electromotive top comprising:
a plurality of motor terminals having opposing ends;
a motor having opposing ends with one end connected to one of said ends of said motor terminals;
a motor shaft having opposing ends with one end connected to said opposing end of said motor;
a spindle sleeve having a top and a bottom, wherein said top of said spindle sleeve defines a hole therein to comprise a second motor shaft hole that receives said opposing end of said motor shaft and said bottom of said spindle sleeve defines a hole therein to comprise a spindle hole;
a flywheel frictionally engaged with said bottom of said spindle sleeve;
a spacer having a middle, wherein said middle of said spacer defines a hole therein to comprise a spindle sleeve hole and said bottom of said spindle sleeve is removably inserted through said spindle sleeve hole;
a spindle nut having a middle and a top, wherein said middle of said spindle nut defines a hole therein to comprise a spindle hole and said top of said spindle nut is frictionally engaged with said spacer; and
a spindle having opposing ends and a middle with one end threadedly connected to said spindle nut and said spindle sleeve; and
a thumbscrew attached to said middle of said spindle.

12. The electromotive top as defined in claim 11, further comprising:
a plurality of capacitors, wherein said capacitors are connected in series by a plurality of capacitor wires to said motor terminals;
a plurality of diodes connected to said capacitors;
a plurality of LED wires having opposing ends with one end connected to said capacitors;
a first LED connected to said opposing end of said LED wires; and
a second LED connected to said opposing end of said LED wires.

13. The electromotive top as defined in claim 1 1, further comprising:
a plurality of battery holder terminals removably attached to said motor terminals;
a battery holder having opposing ends with one end attached to said battery holder terminals; and
a battery inserted into said battery holder.

14. The electromotive top as defined in claim 13, further comprising:
a housing having a top and a bottom enclosing said top of said motor;
a plurality of motor terminal holes, wherein said top of said housing defines holes therein to comprise said motor terminal holes;
a facing having a middle attached to said bottom of said housing; and
a first motor shaft hole, wherein said middle of said facing defines a hole therein to comprise said first motor shaft hole.

15. The electromotive top as defined in claim 13, wherein said battery holder terminals are disconnected from said motor terminals once said motor reaches the desired speed of rotation until said electromotive top stops spinning.

16. The electromotive top as defined in claim 12, wherein said spindle sleeve is transparent or translucent.

17. The electromotive top as defined in claim 12, further comprising a light groove, wherein said top of said spindle sleeve defines a groove therein to comprise said light groove.

18. The electromotive top as defined in claim 11, wherein said bottom of said spindle sleeve is adapted to fit the center hole of at least one standard compact disc.

19. The electromotive top as defined in claim 11, wherein said flywheel is a standard compact disc.

20. A method of using an electromotive top comprising the steps of:
obtaining an electromotive top as defined in claim 3;
holding said electromotive top in an upright position by said opposing end of said motor;
connecting said battery holder terminals to said motor terminals;
waiting for said motor to bring said top body and said flywheel to the desired speed of rotation;
disconnecting said battery holder terminals from said motor terminals;
placing said bottom of said top body on a surface; and
waiting for said electromotive top to stop spinning.
